(19) United States
(12) Patent Application Publication
(10) Pub. No.: US 2009/0112915 A1
(43) Pub. Date: Apr. 30, 2009

(54) Class configuration for locally cached remote data binding

(75) Inventors: Milind J. Lele, Sammamish, WA (US); Amzee Carlton Lane, Tokyo (JP)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/981,108

(22) Filed: Oct. 31, 2007

(51) Int. Cl. G06F 7/00

(52) U.S. Cl. 707/102; 707/E17.044

(57) ABSTRACT

Data-driven applications are often designed to couple with a remote data store, such as a relational database server. It may be difficult for developers to implement complex details of the synchronization, including data caching and concurrency management, and developers may be unable to use synchronization code libraries without specialized knowledge of such issues. A data-binding model may be provided to simplify the developer's task of coupling a class in a data-driven application with a remote data store. The development platform may allow the developer to specify the data-bound properties of a class and the aspects of a remote data store for the binding relationship, and may automatically reconfigure the class to implement the many details of binding to the remote data store.

### BACKGROUND

Object-oriented programming provides for the definition of classes as collections of many kinds of properties (including member objects and simple variable types, like integers and strings, which may be accessed directly or through one or more accessors) and other class members. Such classes may be designed to work with other classes, and on occasion, a value in one object is data-bound to a value in another object in order to maintain synchrony between the two values. For example, if a sample class has a “name” property, and if a textbox object (e.g., displayed in a window or web browser page) is configured to display the name of an object of this sample class, then the contents of the textbox (as the “bound” property) may be data-bound to the “name” property of the sample class. This binding ensures that when an instance of the textbox class (also known as an object) is associated with an instance of the sample class, the bound value (the contents of the textbox object) are automatically kept in synchrony with the “name” property of the binding value (the value of the “name” property of the sample class object.) Such data binding permits the designer to couple the bound value (the textbox contents) and the binding property (the “name” property) in a simple manner, without having to write lengthy portions of code for implementing the synchronization (e.g., configuring the binding class to raise an event when the binding property is changed; configuring the bound class to subscribe to the events of the binding class, and to handle raised events by updating the bound property; etc.)

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Data-driven applications may be coupled with a remote data store, such as a relational database provided by a database server. The synchronization of the data-driven application with the remote data store may be technically complex, involving difficult-to-implement techniques such as data caching, concurrency resolution, atomic transactions, and subscriber models. Many code libraries have been created to implement many facets of the remote data store synchronization process, and to enable developers to invoke methods and utilize classes of the code libraries to perform these complex synchronization techniques. However, the onus is often left to the developer to specify many details of the synchronization, and may be cognizable only by developers who have advanced knowledge of relational database theory and network communication techniques.

It may be advantageous to permit developers of data-driven applications to couple a class with a synchronization library through a simple data-binding mechanism. Instead of placing the onus on the developer to describe the synchronization in detail, the developer may be permitted to indicate the properties of a class that are to be synchronized with certain aspects of a particular remote data store. The development platform may permit the developer to identify the bound data members, the remote data store, and the aspects of the remote data store that participate in the binding relationship. Accordingly, the development platform may then automatically reconfigure the class to implement the remote data binding, e.g., by creating a local cache that is configured to synchronize the binding aspects of the remote data store, and by data-binding the bound properties of the class to the corresponding properties in the local cache. This mechanism permits developers to enact remote data binding in a simple and quick manner, and with no special knowledge of the techniques involved.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flowchart illustration of an exemplary method of fulfilling a request to bind a class to a remote data store.

FIG. 2 is a component block diagram of an exemplary system configured to fulfill a request to bind a class to a remote data store.

FIG. 3A is a component block diagram of a portion of an exemplary system configured to fulfill a request to bind a class to a remote data store.

FIG. 3B is a component block diagram of another exemplary system configured to fulfill a request to bind a class to a remote data store.

FIG. 4A is a component block diagram of a portion of another exemplary system configured to fulfill a request to bind a class to a remote data store.

FIG. 4B is a component block diagram of a portion of yet another exemplary system configured to fulfill a request to bind a class to a remote data store.

FIG. 4C is a component block diagram of a portion of yet another exemplary system configured to fulfill a request to bind a class to a remote data store.

FIG. 5 is an illustration of an exemplary computer-readable medium comprising processor-executable instructions configured to perform a method or implement a system such as disclosed herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Data-driven applications are typically configured to request data from a data store (deployed locally or remotely) via a query, such as a Structured Query Language (SQL) query, and to incorporate the data returned from the data store as part of the application data set, e.g., by storing the returned data in one or more properties of class instances utilized in the application. With the increasing availability, sophistication, and performance of many data stores, such as sophisticated relational databases, data-driven applications are being more widely developed to access a broader range of data stores for various purposes. In some instances, the data-driven application may be little more than a thin client configured to display very complex information provided by the data store.

However, data-driven applications are often difficult to implement. The process of performing such synchronization may involve negotiating a connection with the data store, providing the query in the proper language and with correct syntax, receiving the results synchronously or asynchronously, processing the results, sending new data back to the server (e.g., via INSERT, UPDATE, and DELETE queries, table maintenance operations such as creation and refactoring, etc.), and handling the many types of errors and exceptions arising during these tasks. These functions may be difficult to configured correctly, and the code involved may be lengthy, tedious, nuanced, and prone to changes upon alterations in the configuration and structure of the data store. Moreover, if the data store is deployed remotely, e.g., provided by a database server, the data-driven application also involves managing a communications channel with the remote data store, adjusting the utilization of the remote data store with respect to the nature of the communications channel (e.g., coping with low-bandwidth or high-latency connections by caching more data), and handling errors related to the communications channel. The technological issues may be compounded where the remote data store is concurrently accessed by many users, where the data-driven application may include concurrency issues and a capability for performing atomic transactions on the remote data store.

Accordingly, developers may be stymied by the complexities of synchronizing a data-driven application with a remote data store, because the code involved may be disproportionately difficult. Developers might also attempt to utilize one of the many code libraries available for performing such synchronization. Many such code libraries serves as an interface for handling some of the complexities, but the developer may still have to specify many details about the synchronization, such as when to perform the synchronization, how to resolve disparities between the data-driven application and the remote data store, and how to subscribe to data updates provided by the remote data store. The developer may be able to utilize such code libraries only with specialized knowledge of relational database theory and network communication.

An alternative technique for assisting developers of data-driven applications relates to the data binding model for synchronizing properties between and among local instances of various classes. This data binding model permits a developer to link one property of one class (the bound property) to remain in synchrony with a property of another class (the binding property.) In the absence of data binding mechanisms, a developer may implement this synchronicity only by writing lengthy code to establish relationships among instances of the bound class and the binding class, to configure the binding class to raise events upon changes in the binding properties of the class instances, and to configure the bound class instances to receive such events and incorporate the results. However, the data binding mechanism permits developers to enact the details of this binding simply by indicating the bound property of the bound class and the binding property of the binding class to which the bound property is linked. Development platforms that permit such data binding may effectuate the developer's design specification by automatically reconfiguring the binding and bound classes to interoperate, e.g., by inserting auto-generated code into these classes for performing the synchronization. The system might also permit the developer to reconfigure the auto-generated code in order to adjust the details of the binding (e.g., the particular queries used to retrieve and update data.)

The data binding model is available for performing object-property-to-object-property data binding, but the model has not been applied to the field of remote data synchronization. A software development environment equipped with components for providing the automated configuration of classes for synchronization with remote data stores via a data-binding model may facilitate the rapid development of data-driven applications. Moreover, such applications may be created by developers with less specialized knowledge of data stores and network communication techniques.

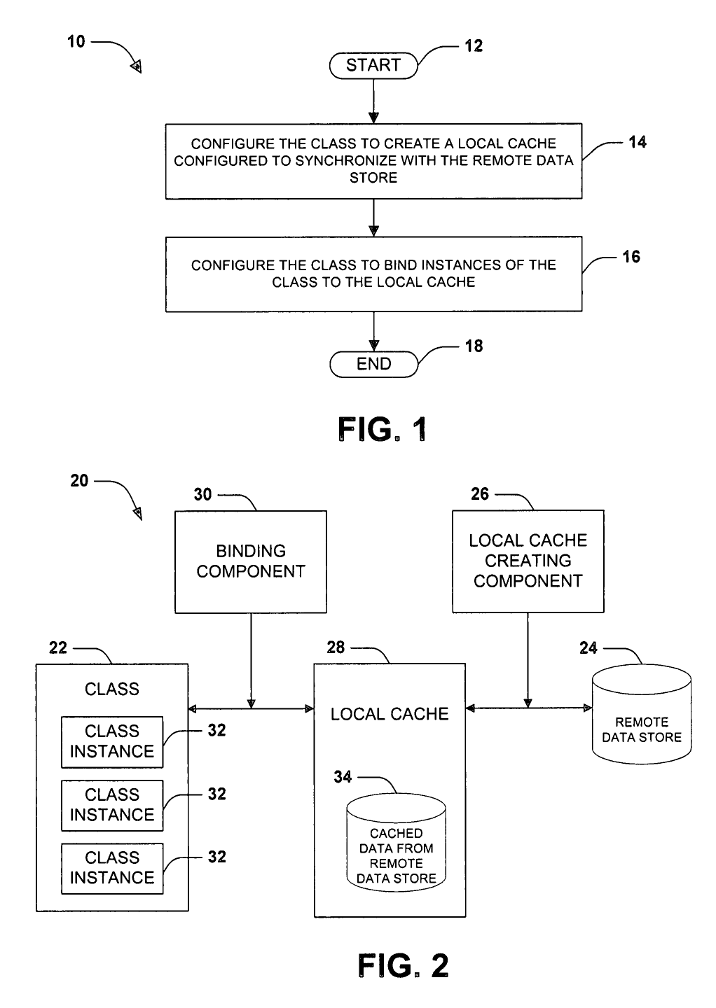

One example of this technique is illustrated in FIG. 1, which presents a computer-implemented method 10 of fulfilling a request to bind a class to a remote data store. This exemplary method 10 begins at 12 and involves configuring the class to create a local cache configured to synchronize with the remote data store 14. The method 10 also involves configuring the class to bind instances of the class to the local cache 16. Upon applying these configuration techniques, the method 10 achieves the fulfillment of the request to bind the class to the remote data store, and therefore the method 10 ends at 18.

The exemplary computer-implemented method 10 of FIG. 1 may be performed in many variations, which may provide advantages and/or mitigate disadvantages with respect to other implementations and conventional techniques. As one example, the class may be configured to create the local cache upon the designation of the class for remote data binding (e.g., at design time), or upon the compilation of an application including the class (e.g., at compile time), or upon execution of an application including the class, or upon the instantiation of the class, or upon connecting to the remote data store, etc. As another example, the class may be configured to bind a class instance to the local cache by binding the entire class instance to the local cache, i.e., all accessible properties are synchronized with the local cache; or by binding one or more data-bound properties of the class instance to the local cache; or by implementing the class instance as a reference to the version of the data stored in the local cache. As yet example, the creation of the local cache for synchronization and the configuration of the class for binding to the local cache 16 may be performed in either order, or simultaneously (e.g., by multiple threads executing in parallel on a multi-core processor.) As a final example, the local cache may be created in system memory, or on a storage device such as a hard disk drive or optical disk, or on a second remote data store (e.g., as a file in a network file system provided by a network file server.) It will be appreciated that those of ordinary skill in the art may devise many variations of the exemplary method 10 of FIG. 1 that utilize the techniques discussed herein.

These techniques may also be implemented as a system, such as the exemplary system 20 of FIG. 2. This exemplary system 20 is configured to fulfill a request to bind a class 22 to a remote data store 24. The exemplary system 20 comprises a local cache creating component 26 configured to create a local cache 28 configured to synchronize with the remote data store 24, and a binding component 30 configured to bind instancess of the class 22 to the local cache 28. By providing such components configured to create the local cache 28 and to bind instances of the class 22 to the remote data store 24 through the local cache 28, the exemplary system 20 fulfills the binding request.

The exemplary system 20 may also be implemented with many variations that provide advantages and/or mitigate disadvantages with respect to other implementations and conventional techniques. As one example, the local cache creating component 26 may be embedded in the code for the class 22, e.g., by inserting instructions in the constructor for the class 22 that produces the local cache 28. Alternatively, the local cache creating component 26 may be a tool provided in the development environment, by the operating system, or as part of a runtime or dynamic link library. As another example, the local cache creating component 26 and the binding component 30 may be devised as two distinct components, e.g., as two different tools for performing the configurations of the class, or as one component, e.g., a tool for performing both configurations of the class. It will be appreciated that those of ordinary skill in the art may devise many variations of the exemplary system 20 of FIG. 2 that utilize the techniques discussed herein.

These techniques, including the implementations presented as the exemplary method 10 of FIG. 1 and the exemplary system 20 of FIG. 2, involve the creation of a local cache configured to synchronize with the remote data store, and the binding of instances of the class to the local cache. However, these techniques are related to the configuration of the class such that these events occur, and may not pertain to the moment that such events occur. The configuration may be advantageously utilized as a design-time technique, e.g., as part of a development environment, such that the developer may invoke the techniques through a design tool included in the development environment. By configuring the code base for a class to invoke these techniques for creating the local cache configured to synchronize with the remote database, and for binding the instances of the class to the local cache, this development tool may permit a developer to configure the application for the remote data store synchronization, and may not pertain to the particular details of the synchronization. Thus, while some embodiments of these techniques may be involved in the actual synchronization or binding (e.g., the configuration may comprise auto-generated code inserted in various methods of the class that invoke the binding component at runtime), other embodiments may not pertain to the techniques for performing the synchronization or binding, and may simply configure the class to accomplish such synchronization or binding through other components of the operating system or runtime, etc.

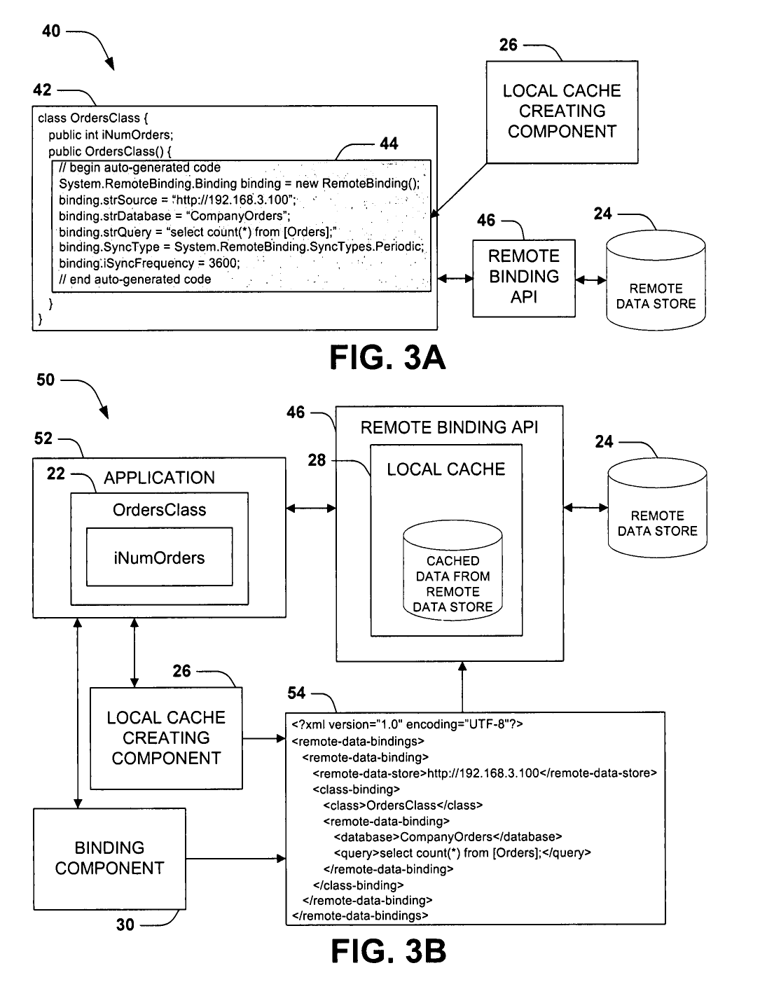

Two such embodiments are illustrated in FIGS. 3A and 3B. In both embodiments, the synchronization is performed during runtime by a separate component comprising an advanced programming interface (API), which may be provided by the operating system or a runtime to perform various operations on remote data stores. In the exemplary system 40 of FIG. 3A, the local cache creating component 26 configures the OrderClass class to generate a local cache configured to synchronize with the CompanyOrders database comprising the remote data store 24. More specifically, in this exemplary system 40, the local cache creating component 26 configures the class by configuring the source code 42 comprising the class, and in particular by inserting some auto-generated code 44 into the portion of the source code 42 comprising the class constructor. The auto-generated code 44 is configured to invoke a remote binding API 46, and to configure the invocation for generating a local cache configured to synchronize with the remote data store 24 (in particular, by executing an SQL query on the remote data store 24 configured to retrieve the total number of records in the “Orders” table.) The data retrieved from the remote data store 24 may then be bound to a data-bound property of the class. For example, the binding component (not shown) may insert another set of auto-generated code into other portions of the source code 42 to bind one or more properties of the class to the data in the local cache (in this case, the likely data-bound property of the OrderClass class is the iNumOrders property.) In this manner, the local cache creating component 26 achieves the creation of the local cache and the configuration of the local cache with the remote data store 24 by configuring the source code 42 of the class, which may be completed well before the synchronization occurs.

Another exemplary system 50 is provided in FIG. 3B, which illustrates another embodiment in which the configuration of the class may be completed at design time. This exemplary system 50 is applied to a data-driven application 52 that includes a class 22 having at least one data-bound property, i.e., the iNumOrders property of the OrderClass class. In particular, the local cache creating component 26 and the binding component 30 together complete the configuration of the class 22 at design time by generating a binding descriptor file 54, which includes the information in the request provided by the developer to bind the data-bound property of the class 22 to the remote data store 24. The binding descriptor file 54 in this exemplary system 50 comprises an XML file that specifies the remote data store, at least one bound property of the class, and the objects of the remote data store to store in the local cache and bind to the at least one bound property of the class. The binding descriptor file 54 may be operably coupled with a combined binary for the data-driven application 52, e.g., by embedding or linking the binding descriptor file 54 in the manifest for the compiled binary of the data-driven application 52, or by storing the binding descriptor file 54 together with the compiled binary and with a predictable filename (e.g., “MyApplication.exe” stored together with “MyApplication.exe.bindings”.) Upon execution of the binary, a remote binding API 46 may consume the binding descriptor file 54 by parsing it and performing the data binding (e.g., by creating the local cache configured to synchronize with the remote data store 24, and by binding the data-bound property of the class 22 to the local cache 28.) Again, this exemplary system 50 completes the configuration of the class 22 for the binding of the data-bound property of the class 22 with the remote data store 24 at design time, such that the techniques thereby performed will effectuate the data binding at runtime. It will be appreciated that those of ordinary skill in the art may devise many variations of the configuration of the class 22, e.g. at design time or runtime, that utilize the techniques discussed herein.

The local cache may be created in several embodiments according to various implementations, which may present some advantages and/or mitigate disadvantages with respect to other embodiments and conventional techniques. The following examples may be more easily appreciated with reference to the components of the exemplary system 20 illustrated in FIG. 2. As one example, the local cache creating component 26 may be configured to create the local cache 28 and to configure the local cache 28 in different manners. In one embodiment, the local cache creating component 26 may create the local cache 28 at one point in the development process (e.g., at design time, such as when the developer requests the binding of the class 22 to the remote data store 24; or at compile time of an application including the class 22 or upon execution of an application including the class 22; or upon instantiation of an instance of the class 22, or upon encountering a code reference to a bound property of the class 22 (i.e., on a just-in-time basis.) Similarly, the local cache creating component 26 may be configured to create and configure the local cache 28 either together or at different times, e.g., by allocating space for the local cache 28 upon execution of an application including the class 22 and configuring the local cache 28 to synchronize with the remote data store 24 upon instantiation of the class 22. As another example, the local cache creating component 26 may configure the class 22 by inserting auto-generated code for completing the creation of the local cache 28, or by inserting a reference to a runtime component that monitors the instantiation of the class and conducts the creation of the local cache 28 and the configuration of the local cache to synchronize with the remote data store 24.

Another set of variations related to creation and configuration of the local cache (such as the local cache creating component 26 in the exemplary system 20 of FIG. 2) relates to the configuration of the local cache to synchronize with the remote data store. As one example, the local cache 28 may be configured to synchronize with the remote data store 24 upon various events. In one embodiment, the local cache 28 is configured to synchronize with the remote data store 24 periodically, e.g., once per hour during the runtime of the application. In another embodiment, the local cache 28 is configured to synchronize with the remote data store 24 upon receiving a synchronization request, e.g., an instruction included in the code to synchronize the remote data store 24 (e.g., while performing a method of the class 22 that involves up-to-date data from the remote data store 24), or upon a request from a user of the application to fetch the most recent data from the remote data store 24. In yet another embodiment, the local cache 28 may be configured to attempt sporadic communication with the remote data store, and may be further configured, upon detecting an interrupted connection with the remote data store, to reestablish the connection with the remote data store 24 and to synchronize upon reconnecting to the remote data store 24. This technique may be advantageously combined with other synchronization techniques, such as periodic synchronization. Thus, the local cache 28 may be configured for sporadic synchronization with the remote data store 24, and if a sporadic synchronization attempt fails due to a broken connection, the local cache 28 may be configured to synchronize upon reconnecting with the remote data store 24. Such a combined technique may be useful for retaining up-to-date data in a rapidly changing remote data store 24 without involving a persistent connection (e.g., in sporadically connected environments, such as unreliable wireless data connections.)

In yet another embodiment of the configuration of the local cache in synchronizing with the remote data store (such as the local cache 28 synchronized with the remote data store 24 in the exemplary system 20 of FIG. 2), the local cache 28 may be configured to subscribe to the remote data store 24 for receiving updates to the remote data store 24. This embodiment differs from the other synchronization techniques by utilizing a “push” model, where updates to the remote data store 24 are automatically sent to the local cache 28, without depending on “pull” models, in which the local cache 28 polls the remote data store 24 for updates. The subscription mode embodiment may be advantageous because the remote data store 24 may be more capable of determining when the remote data store 24 is updated, which both provides updates to the local cache 28 sooner than a blind polling of the remote data store 24 by the local cache, and also reduces inefficient polling of the remote data store 24 by the local cache 28 when no updates are available. However, the subscription technique may be more resource-intensive, as it may involve retaining a persistent connection between the local cache 28 and the remote data store 24, and retaining on the remote data store 24 various details about the persistent connection (e.g., the location of the local cache 28 and the portions of the remote data store 24 to which the local cache 28 is subscribed.) It may be appreciated that those of ordinary skill in the art may devise many such configurations of the synchronization of the local cache 28 with the remote data store 24 that implement the techniques discussed herein.

Still another set of variations relating to the local cache (once again described with reference to FIG. 2) involves the parameters that the developer specifies in order to establish the binding of the class 22 to the remote data store 24. For example, the developer may request the binding of the class 22 to the remote data store 24 by specifying the remote data store 24, at least one bound property of the class 22, and at least one aspect of the remote data store 24 to store in the local cache 28 and bind to the at least one bound property of the class 22. The aspect of the remote data store 24 may comprise a value stored in a record of the remote data store 24, e.g., a string representing a telephone number of a customer, or a value derived from the remote data store 24, e.g., the number of records in a data table. The aspect of the remote data store 24 may alternatively comprise an object of the remote data store 24, e.g., an entire record, data table, or database, or an object modeled in the remote data store 24, e.g., an object of the class 22 that is serialized and stored as a record in an object-oriented database. As a more specific example, a developer may identify a remote data store provided by a remote data store server, e.g., the “CompanyOrders” database stored on a relational database server located on an intranet at IP address 192.168.2.100. The developer may also specify that certain objects of the remote data store are to be bound to particular properties of the class, e.g., a class named “OrderClass” comprising an “iNumOrders” integer property may be bound to the total number of orders in an “Orders” data table of the “CompanyOrders” database on the specified relational database server.

Components devised to implement such techniques (e.g., the local cache creating component 26 and the binding component 30) may fulfill the request by configuring the class 22 to create the local cache 28 configured to synchronize with the remote data store 24 and to bind the class 22 to the local cache 28. For example, the local cache creating component 26 may respond to this exemplary request by generating instructions in the constructor of the “OrderClass” class for allocating a local cache 28 (e.g., a DataSet object) that contains the information provided by the developer (e.g., the location of the “CompanyOrders” database and the objects on the database to be synchronized.) The local cache creating component 26 may also configure the local cache 28 to synchronize with the remote data store, e.g., by auto-generating SQL statements that perform select, insert, update, and delete statements used in performing the synchronization, and by configuring the class to invoke the synchronization function upon various events (e.g., a timer configured to invoke the synchronization periodically, or a function that may be invoked by the user or developer to perform the synchronization.)

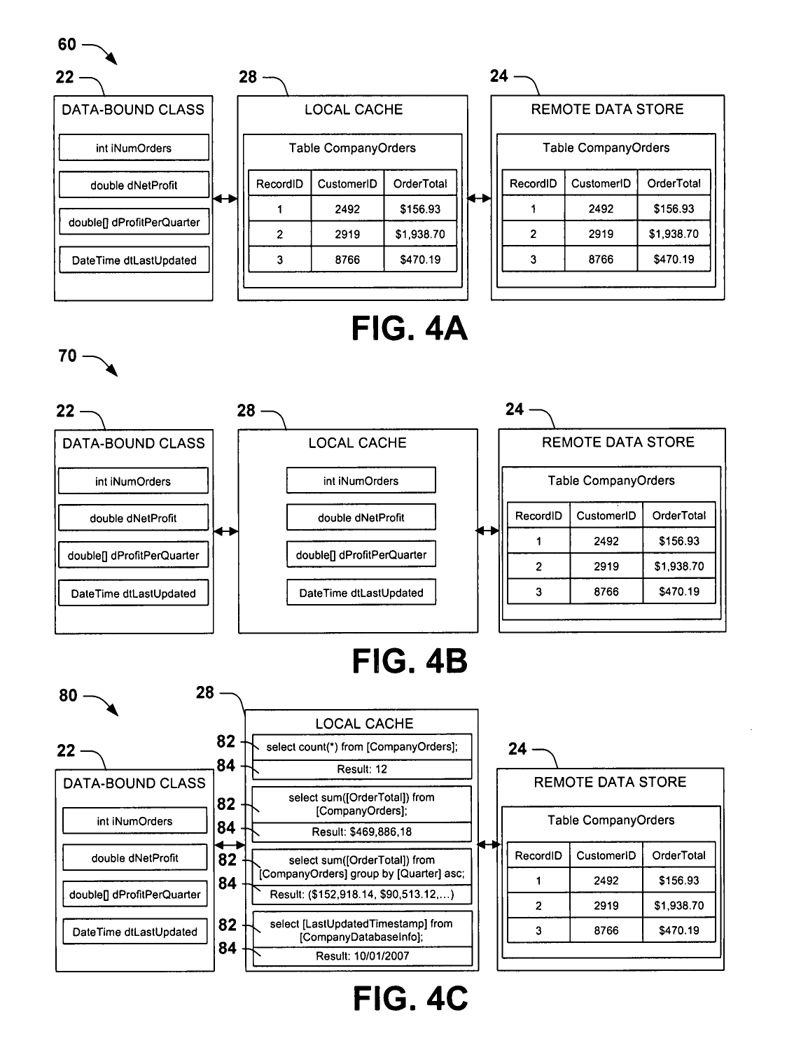

As another example, the local cache 28 may be configured in many variations, and some illustrations of these configurations are presented in FIGS. 4A-4C. In one embodiment 60 illustrated in FIG. 4A, the local cache 28 is structured according to at least a portion of a schema of the remote data store 24, e.g., the data tables and attributes of a relational database that are to be synchronized (such as where the local cache 28 comprises a data set retrieved from the remote data store 24, and is organized as reflection of the elements of the remote data store 24, such as the data tables and table attributes of a relational database.) In this embodiment 60, the synchronization is performed by synchronizing the modeled objects of the local cache 28 (e.g., the locally stored copies of the data tables) with the corresponding aspects of the remote data store 24. Another embodiment 70 is illustrated in FIG. 4B, in which the local cache 28 is structured according to at least one bound property of the class 22 that the local cache 28 is devised to support, e.g., the properties of the class 22 that are to be filled with data from the remote data store 24. Yet another embodiment 80 is illustrated in FIG. 4C, in which the local cache 28 is structured according to at least one data set 84 returned by a synchronization query 82 executed on the remote data store 24, such as a Structured Query Language (SQL) query designed to produce the data consumed by the data-driven application (e.g., “select count(*) from [CompanyOrders];” to supply the “iNumOrders” property of the “OrderClass” class.) In this embodiment, the synchronization is performed by performing the synchronization query 82 on the remote data store 24 and by updating one or more objects in the local cache 28 based on the data set 84 returned by the synchronization query 82. It may be appreciated that those of ordinary skill in the art may devise many such techniques for configuring a local cache 28 in order to fulfill a request to bind a class 22 to a remote data store 24 that implement the techniques discussed herein.

Still another set of variations in the implementation of the local cache relates to the configuration of the local cache to synchronize with the remote data store using one or more synchronization attributes. Systems devised to implement these techniques (such as the exemplary system of FIG. 2) might include a synchronization attribute component that is configured to receive at least one synchronization attribute and to configure the local cache 28 to synchronize with the remote data store 24 using the synchronization attribute. This variation provides a customizable aspect to the synchronization that may be altered in reflection of various circumstances. Such synchronization attributes may be provided, e.g., by the developer, a user of the remote data store, the operating system, a runtime, and/or an advanced programming interface (API) involved in the synchronization. The synchronization attributes may also pertain to the connection of the local cache 28 with the remote data store 24, and/or to the manner of synchronizing the local cache 28 with the remote data store 24. It may be appreciated that those of ordinary skill in the art may devise many techniques for configuring the local cache 28 to utilize various synchronization attributes while implementing the techniques discussed herein.

Many such exemplary synchronization attributes may be supplied to the local cache 28 for synchronization with the remote data store 24. As one example, the synchronization attribute may comprise the synchronization frequency with which the local cache 28 is synchronized with the remote data store 24, which may be specified by the developer of the data-driven application involving the class 22. As another example, the synchronization attribute may comprise a synchronization query provided by the developer to perform various aspects of the synchronization. A developer may specify that the local cache 28 checks for updates to the remote data store 24 by executing a customized query against the relational database (e.g., “select* from [Orders] where [Timestamp]>#1/1/2007 1:39pm#;” may be applied to the “CompanyOrders” database where the developer wishes the local cache to be updated with remote data store entries updated since the last synchronization attempt at 1:39 pm on Jan. 1, 2007.) As still another example, the synchronization attribute may also comprise a connection parameter that the local cache 28 includes in the connection string provided to connect to the remote data store 24. A connection parameter of this type may comprise a username and password, which may be specified by a user during runtime of a data-driven application that synchronizes with a remote data store 24 utilizing account-based security. The developer might configure such a data-driven application to request the username and password from the user at runtime, and to provide any such parameters provided by the user to the local cache 28 for use in establishing secured access to the remote data store 24.

As yet another example of a synchronization attribute used in synchronizing the local cache 28 with the remote data store 24, the synchronization attribute may comprise a synchronization rule, which may indicate how discrepancies between the data stored in the local cache 28 and the remote data store 24 are to be reconciled. The synchronization rule may specify that the remote data store 24 is read-only and cannot be updated by the local cache 28, so that all data updates overwrite the contents of the local cache 28. Alternatively, the synchronization rule may specify that the remote data store 24 is writeable, and is to be updated with all of the updates provided to data in the local cache 28. This implementation may be useful where the remote data store 24 comprises a data backup of the class 22 bound to the remote data store 24 through the local cache 28. As a second alternative, the synchronization rule may specify that the local cache 28 and the remote data store 24 are bidirectionally synchronized, such that the most recent updates to either data source are applied to the other data source. A timestamp system may be included in the synchronized data to facilitate such bidirectional synchronization.

Still another variation in the implementation of the local cache (once again described with reference to FIG. 2) relates to the connection of the local cache 28 to a local cache query processor, which may be configured to process queries on the data stored in the local cache 28. If the data stored in the local cache 28 is a reflection of structured data, e.g., of data objects stored in a relational database, then it may be advantageous for the data-driven application to perform relational data queries on the structured data stored in the local cache 28. For example, the local cache 28 may comprise a cached version of a data table stored in the relational database that is utilized as the remote data store 24. The data-driven application might apply a query to the data table of the remote data store 24 by applying the query to the cached version of the data table in the local cache 28. For example, if the local cache 28 contains a copy of the “Orders” table of the “CompanyOrders” database in the remote data store 24, then queries may be executed against the “Orders” table (e.g., “select count(*) from [Orders];”) by applying them to the cached copy in the local cache 28. Such queries might be executed against the local cache 28 by connecting the local cache 28 to a local cache query processor, which is configured to receive such queries and to apply them to the cached data in the local cache 28. This technique may be advantageous where the remote data store 24 becomes inaccessible, but where the data-driven application continues to bind class instances to the data stored in the local cache 28. This technique may also be advantageous where the data-driven application involves computationally complex queries on the data stored in the local cache 28, which may be inefficient or unavailable for performing on the remote data store 24 (e.g., where the remote data store 24 simply provides particular types of data, and is not configured to receive and process queries.) It may be appreciated that those of ordinary skill in the art may devise many techniques for connecting a local cache query processor to the local cache 28 while implementing the techniques discussed herein.

These techniques are provided to fulfill the request for binding a class to a remote data store by binding an instance of the class to the local cache configured as described herein. The binding of the instances of the class to the local cache may be achieved in many variations that may present advantages and/or mitigate disadvantages with respect to other variations and conventional techniques. These variations may be more easily appreciated with reference to the exemplary system 20 of FIG. 2. As one example variation in the binding of the instances of the class 22 to the local cache 28, the binding may be achieved at various points in the development process. In one embodiment, the class 22 may be implemented as a singleton, which may exist as a single class instance, and may be created upon execution of a data-driven application that includes the class. In this embodiment, the class 22 may be bound to the local cache 28 upon execution of the data-driven application. In another embodiment, the class 22 may bind a class instance to the local cache 28 upon instantiation of the class, e.g., by including code in the constructor of the class 22 that binds instances of the class 22 to the local cache 28. This embodiment may be advantageous for performing the binding early in the life of the class instance, such that the class instance is provided to the application in a ready-to-use state upon completion of the initialization of the class instance. In still another embodiment, the class 22 may bind a class instance to the local cache 28 upon the first synchronization of the local cache with the remote data store 24. This embodiment may be advantageous for delaying the computational burden of binding the class instance to the local cache 28 until the data is available in the local cache 28, which may promote consistency among the data in the class instance (in contrast with the early-binding model, in which the class instance may appear to be bound to the data in the remote data store through the local cache, but may still not contain the desired data until the first synchronization is completed.) In still another embodiment, the class 22 may bind a class instance to the local cache 28 upon encountering a first reference to a bound property of the class instance. This embodiment may be advantageous for further delaying the computational burden of the binding in a “just-in-time” manner, such that the binding (which may involve a computationally complex query run against the local cache) may be delayed until the data provided thereby is used by the data-driven application. It may be appreciated that those of ordinary skill in the art may devise many techniques for binding a class instance to the local cache 28 while implementing the techniques discussed herein.

As another example variation, the binding component 30 may be devised as automatically generated instructions that are inserted in the code for the class 22 upon designating the class for remote data binding, or as a component of a development environment, operating system, runtime, dynamic link library, etc. that performs the binding of an instance of the class 22 to the remote data store 24 at various times, e.g., at design time, at compile time, or at various moments during the runtime of an application including the class 22.

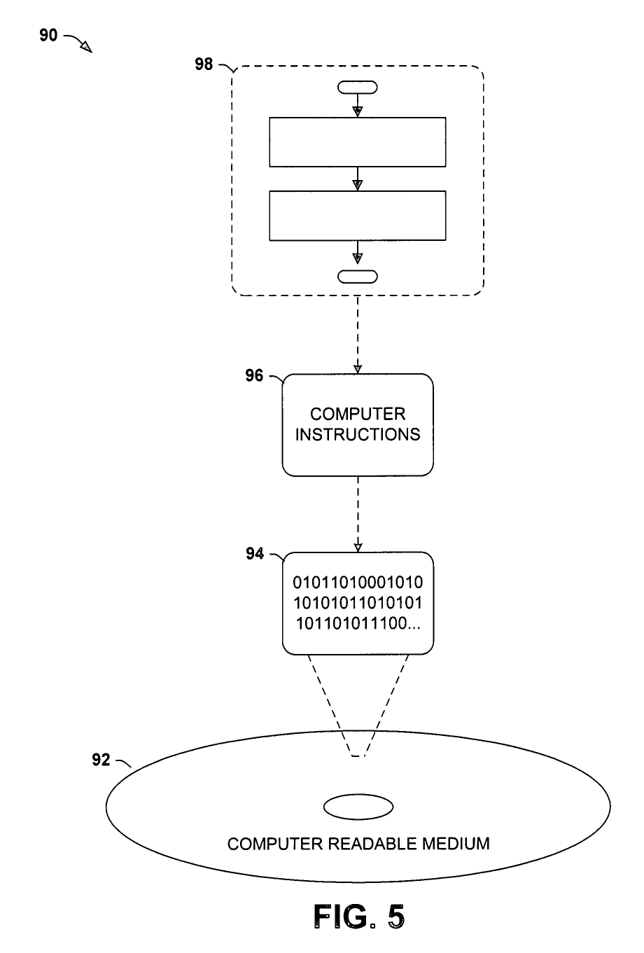

The techniques discussed herein may also be embodied as a computer-readable medium comprising processor-executable instructions configured to create an aggregated user profile as discussed herein. An exemplary computer-readable medium that may be devised in these ways is illustrated in FIG. 5, illustrating an exemplary embodiment 90 comprising a computer-readable medium 92 (e.g., a CD-R, DVD-R, or a platter of a hard disk drive), on which is encoded computer-readable data 94. This computer-readable data 94 in turn comprises a set of computer instructions 96 configured to operate according to the principles set forth herein. For example, and as shown in the exemplary embodiment 90 of FIG. 5, the computer instructions 96 may be configured to perform a method of fulfilling a request to bind a class to a remote data store, such as the exemplary method illustrated in FIG. 1. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it may be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-implemented method of fulfilling a request to bind a class to a remote data store, the method comprising:
configuring the class to create a local cache configured to synchronize with the remote data store, and
configuring the class to bind instances of the class to the local cache.

2. The method of claim 1, the request specifying the remote data store, at least one bound property of the class, and at least one aspect of the remote data store to store in the local cache and bind to the at least one bound property of the class.

3. The method of claim 1, the binding comprising binding at least one property of the instances of the class to at least one aspect in the remote data store.

4. The method of claim 3, the binding comprising at least one of:
setting the bound property of the instances of the class to the aspect in the remote data store, and
setting the aspect in the data store to the bound property of the instances of the class.

5. The method of claim 1, the local cache configuring comprising: structuring the local cache according to at least a portion of a schema of the remote data store.

6. The method of claim 1, the local cache configuring comprising: structuring the local cache according to at least one bound property of the class.

7. The method of claim 1, the local cache configuring comprising: structuring the local cache according to at least one data set returned by a synchronization query.

8. The method of claim 1, comprising: configuring the local cache to synchronize with the remote data store periodically.

9. The method of claim 1, comprising: configuring the local cache to synchronize with the remote data store upon receiving a synchronization request.

10. The method of claim 1, comprising: configuring the local cache to synchronize with the remote data store upon reconnecting to the remote data store after an interrupted connection.

11. The method of claim 1, comprising: configuring the local cache to subscribe to the remote data store for receiving updates to the remote data store.

12. The method of claim 1, comprising: upon receiving at least one synchronization attribute, configuring the local cache to synchronize with the remote data store using the synchronization attribute.

13. The method of claim 12, the synchronization attribute comprising at least one of a connection parameter, a synchronization frequency, a synchronization query, and a synchronization rule.

14. The method of claim 1, comprising: connecting the local cache to a local cache query processor configured to process queries on the data stored in the local cache.

15. A computer-readable medium comprising processor-executable instructions configured to perform a method of fulfilling a request to bind a class to a remote data store, the method comprising:
configuring the class to create a local cache configured to synchronize with the remote data store, and
configuring the class to bind instances of the class to the local cache.

16. A system for fulfilling a request to bind a class to a remote data store, the system comprising:
a local cache creating component configured to create a local cache configured to synchronize with the remote data store, and
a binding component configured to bind instances of the class to the local cache.

17. The system of claim 16, the request specifying the remote data store, at least one bound property of the class, and at least one aspect of the remote data store to store in the local cache and bind to the at least one bound property of the class.

18. The system of claim 16, comprising: a synchronization attribute component configured to receive at least one synchronization attribute and to configure the local cache to synchronize with the remote data store using the synchronization attribute.

19. The system of claim 18, the synchronization attribute comprising at least one of a connection parameter, a synchronization period, a synchronization query, and a synchronization rule.

20. The system of claim 16, comprising: a local cache query processor configured to process queries on the data stored in the local cache.
